(19) United States
(12) Patent Application Publication
(10) Pub. No.: US 2018/0034764 A1
(43) Pub. Date: Feb. 1, 2018

(54) SELECTING APPLICATIONS FOR MESSAGE HANDLING

(71) Applicant: LinkedIn Corporation, Mountain View, CA (US)

(72) Inventors: Rishi Jobanputra, Menlo Park, CA (US); Romer E. Rosales, Burlingame, CA (US); Joshua Daniel Hartman, Mountain View, CA (US); Shubhanshu Nagar, Sunnyvale, CA (US); Ryan Oblak, Mountain View, CA (US); Cameron Alexander Lee, San Ramon, CA (US); Hsiao-Ping Tseng, Fremont, CA (US); Shaunak Chatterjee, Sunnyvale, CA (US); Steven David Heidel, San Francisco, CA (US)

(21) Appl. No.: 15/223,615

(22) Filed: Jul. 29, 2016

(51) Int. Cl. H04L 12/58; H04L 29/06

(52) U.S. Cl. CPC H04L 51/32; H04L 51/24; H04L 65/1063

(57) ABSTRACT

This disclosure relates to systems and methods for selecting an application to handle a message. In one example, a method includes receiving a first message from a first member of an online social networking service using a first computing device, the first message addressed to a second member of the online social networking service, determining which application the first member used to generate the first message, receiving a second message from the second member, the second message being a reply message to the first message, and transmitting the second message to the first computing device that includes an instruction that the determined application is to handle the second message.

### TECHNICAL FIELD

The subject matter disclosed herein generally relates to message transmission for a social networking service, and more particularly, to selecting applications for message handling.

### BACKGROUND

As an online social networking service grows, the network may support a wide variety of different services. In some examples, the online social networking service supports family connections, business connections, employment services, advertising services, or other services. Members of the online social networking service may also desire to transmit messages to each other. Handling messages from a wide variety of different network services is challenging.

### BRIEF DESCRIPTION OF THE DRAWINGS

Some embodiments are illustrated by way of example and not limitation in the figures of the accompanying drawings.

FIG. 1 is a block diagram illustrating various components or functional modules of an online social networking service, in an example embodiment.

FIG. 2 is a block diagram illustrating one example system for selecting an application for message handling according to one example embodiment.

FIG. 3 is a block diagram illustrating another example system for selecting applications for message handling according to one example embodiment.

FIG. 4 is a flow chart diagram illustrating a method of selecting applications for message handling according to an example embodiment.

FIG. 5 is another flow chart diagram illustrating a method of selecting applications for message handling according to an example embodiment.

FIG. 6 is a flow chart diagram illustrating a method of selecting applications for message handling according to another example embodiment.

FIG. 7 is a block diagram illustrating components of a machine able to read instructions from a machine-readable medium.

### DETAILED DESCRIPTION

The description that follows includes systems, methods, techniques, instruction sequences, and computing machine program products that embody illustrative embodiments of the invention described in the present disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

Example methods and systems are directed to selecting applications for message handling. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

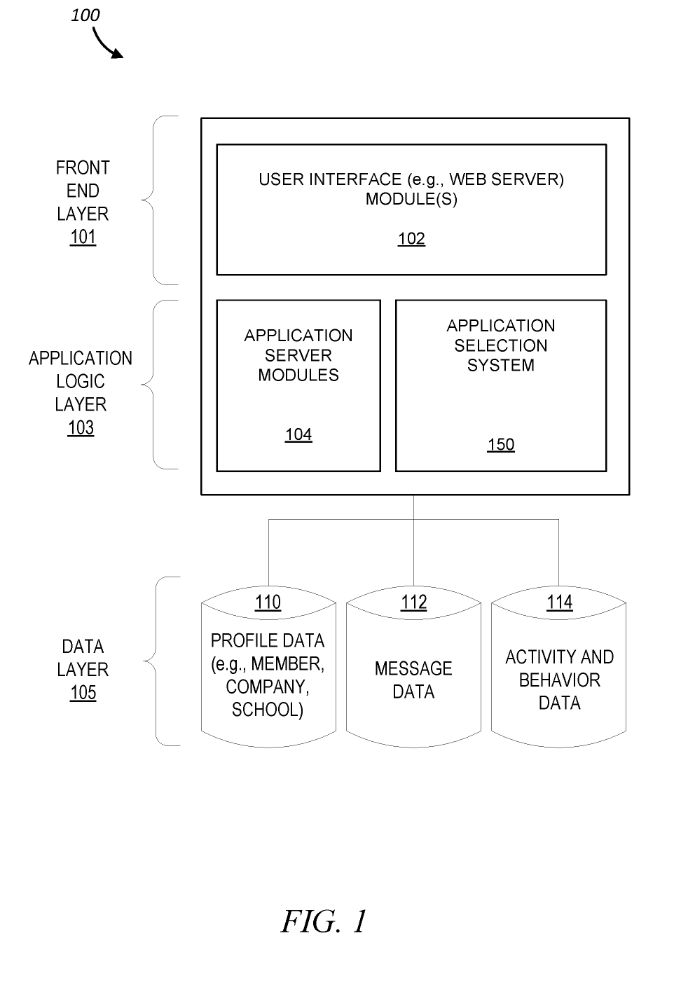

Techniques for selecting an application may be applied to wide range of different scenarios. In one example illustrated in FIG. 1, an application logic layer 103 includes many different applications, and a front end layer 101 provides an interface to the different applications.

As a social networking service grows, providing messages between members via a single interface may result in too many messages and the messages being more difficult to organize. In one example, and as illustrated in FIG. 1, a social networking service 100 provides many different applications tailored to different members' needs. For example, the social networking service 100 may include a cooking application, an employment application, a marketing application, a social application, a personal connections application, or other, or the like. As one skilled in the art may appreciate, the social networking service 100 may provide applications tailored to any specific purpose, organization, category, topic, or the like.

As members of the social networking service 100 send messages to one another, it may be difficult determining which application to use to handle the messages. In one example, members using an employment-seeking application may send messages to each other regarding employment. At a different time, one of the members may send a message to the other member using a cooking application (app). In this scenario, it may be disorientating for the first member to use an employment application to receive a message about cooking. Therefore, as many users use applications that are tailored to specific purposes, determining which application to use to handle the various messages between members of the online social networking service 100 would benefit communications between members of the online social networking service 100.

In one example embodiment, an application selection system 150 receives a message from a source member of the online social networking service 100 using a source computing device (e.g., a client device). In this example embodiment, the message is directed to a destination member of the online social networking service 100. The application selection system 150, in one example embodiment, then determines, in response to more than one application being available via the source computing device, which application the source member used to generate the message. In response to receiving a reply message from the destination member, the application selection system 150 transmits the reply message to the source computing device with an indicator that identifies a specific application to be used to handle the reply message.

In another example embodiment, the computing device used by the destination member does not currently have the needed application for handling the message. In this example embodiment, the application selection system 150 transmits a request to the computing device used by the destination member to install the application needed to handle the message.

In one example embodiment, the application that is used to handle a certain message is not installed on the computing device for the destination member, and the application selection system 150 requests that the message be handled using a different application. In another example embodiment, the application selection system 150 modifies the message so that the application can handle the message. In one example, the message is formatted for a cooking application, but the cooking application is not installed on the computing device. In this example, the application selection system 150 may reformat the message so that an employment application handles the message.

In another example embodiment, the application selection system 150 provides an interface for either the destination member to view the original message or for the source member to access and/or view the message and/or the reply message. In one example embodiment, the application selection system 150 allows a member to view the message using a web interface, as one skilled in the art may appreciate. Therefore, in certain embodiments, the application selection system 150 pushes a notification to an application used to handle a message and allows a pull notification using other applications.

In certain example embodiments, the application selection system 150 determines the application used to transmit the message using at least one of a source message format, a type of the source message, an application used to generate a previous source message, a location of the source member when generating the source message, a personal relationship between the source member and the destination member, or a social network connection strength between the source member and the destination member.

In one example embodiment, the application selection system 150 determines a location of the member (e.g., as determined by a GPS component of a mobile device) and a location of the member's place of employment (e.g., based on the member specifying the location of the place of employment). In response to the member's location coinciding with the location of the member's place of employment, the application selection system 150 determines that the message was generated using a professional application. As one skilled in the art may appreciate, a location may be determined using GPS coordinates, or other location techniques. In these embodiments, the application selection system 150 prompts or initiates a request to the member for permission or consent to use location data associated with the member.

In another example embodiment, the application selection system 150 determines a location of the member and a location of the member's residence (e.g., the member provides an indication of their residence to the application selection system 150). In response to the member's location coinciding with the location of the member's residence, the application selection system 150 determines that the message was generated using a personal application.

In one example embodiment, the application selection system 150 determines that a member's is personally connected to a destination member (e.g., based on member relationships provided by the member). In response to the destination member being family or a connected romantically (e.g., such as a girlfriend, boyfriend, lover, spouse, etc.). In response to a message being directed to a member that is personally connected to the member sending the message, the application selection system 150 determines that the member is using a personal application to generate the message.

In another example embodiment, the application selection system 150 transmits a notification to a computing device for a member, the notification indicating which application is used to handle the message. In response to the user selecting the notification, the application is loaded and pulls the message from a server.

FIG. 1 is a block diagram illustrating various components or functional modules of an online social networking service 100, in an example embodiment. The online social networking service 100 may be utilized to select an application for message handling. In one example, the online social networking service 100 includes the application selection system 150 that performs the various application selection operations described herein.

A front end layer 101 consists of a user interface module (e.g., a web server) 102, which receives requests from various client-computing devices and communicates appropriate responses to the requesting client devices. For example, the user interface module(s) 102 may receive requests in the form of Hypertext Transport Protocol (HTTP) requests, or other web-based, application programming interface (API) requests. In another example, the front end layer 101 receives requests from an application executing via a member's mobile computing device. In one example, a member submits media content for inclusion in the online social networking service 100, or requests media content from the online social networking service 100. In another example embodiment, a user interface module 102 provides a user interface for a member of the online social networking service 100 to retrieve a message.

An application logic layer 103 includes various application server modules 104, which, in conjunction with the user interface module(s) 102, may generate various user interfaces (e.g., web pages, applications, etc.) with data retrieved from various data sources in a data layer 105.

In some example embodiments, individual application server modules 104 may be used to implement the functionality associated with various services and features of the online social networking service 100. For instance, the ability of an organization to establish a presence in the social graph of the online social networking service 100, including the ability to establish a customized web page on behalf of an organization, and to publish messages or status updates on behalf of an organization, may be services implemented in independent application server modules 104. Similarly, a variety of other applications or services that are made available to members of the online social networking service 100 may be embodied in their own application server modules 104. Alternatively, various applications may be embodied in a single application server module 104.

In some examples, the online social networking service 100 includes the application selection system 150, such as may be utilized to receive a message from a source member of an online social networking service 100 using a source computing device, determine which application the source member used to generate the message, receive a reply message from the destination member, and transmit the reply message to the source computing device including indication that the application is to be used to handle the reply message.

As illustrated, the data layer 105 includes, but is not necessarily limited to, several databases 110, 112, 114, such as a database 110 for storing profile data, including both member profile data as well as profile data for various organizations. Consistent with some example embodiments, when a person initially registers to become a member of the online social networking service 100, the person may be prompted to provide some personal information, such as his or her name, age (e.g., birthdate), gender, interests, contact information, home town, address, the names of the member's spouse and/or family members, educational background (e.g., schools, majors, matriculation and/or graduation dates, etc.), employment history, skills, professional organizations, and so on. This information is stored, for example, in the database 110. Similarly, when a representative of an organization initially registers the organization with the online social networking service 100, the representative may be prompted to provide certain information about the organization. This information may be stored, for example, in the database 110, or another database (not shown). With some examples, the profile data may be processed (e.g., in the background or offline) to generate various derived profile data. For example, if a member has provided information about various job titles the member has held with the same or different companies, and for how long, this information can be used to infer or derive a member profile attribute indicating the member's overall seniority level, or seniority level within a particular company. With some examples, importing or otherwise accessing data from one or more externally hosted data sources may enhance profile data for both members and organizations. For instance, with companies in particular, financial data may be imported from one or more external data sources, and made part of a company's profile.

The online social networking service 100 may provide a broad range of other applications and services that allow members the opportunity to share and receive information, often customized to the interests of the member. For example, with some examples, online social networking service 100 may include a photo sharing application that allows members to upload and share photos with other members. With some examples, members may be able to self-organize into groups, or interest groups, organized around a subject matter or topic of interest. In certain embodiments, other applications include a cooking application, an employment application, a personal social application, a professional networking application, or other application.

In another example embodiment, the application selection system 150 stores messages in the message data database 112. The application selection system 150 may also store any and/or all message-related information in the message data database 112. In one example, the application selection system 150 stores a source application for a message. Therefore, in response to receiving a reply to a message, the application selection system 150 may determine to send the reply message to the application used to transmit the original message. In another example, the application selection system 150 tracks messages and responses to the messages in the message data database 112.

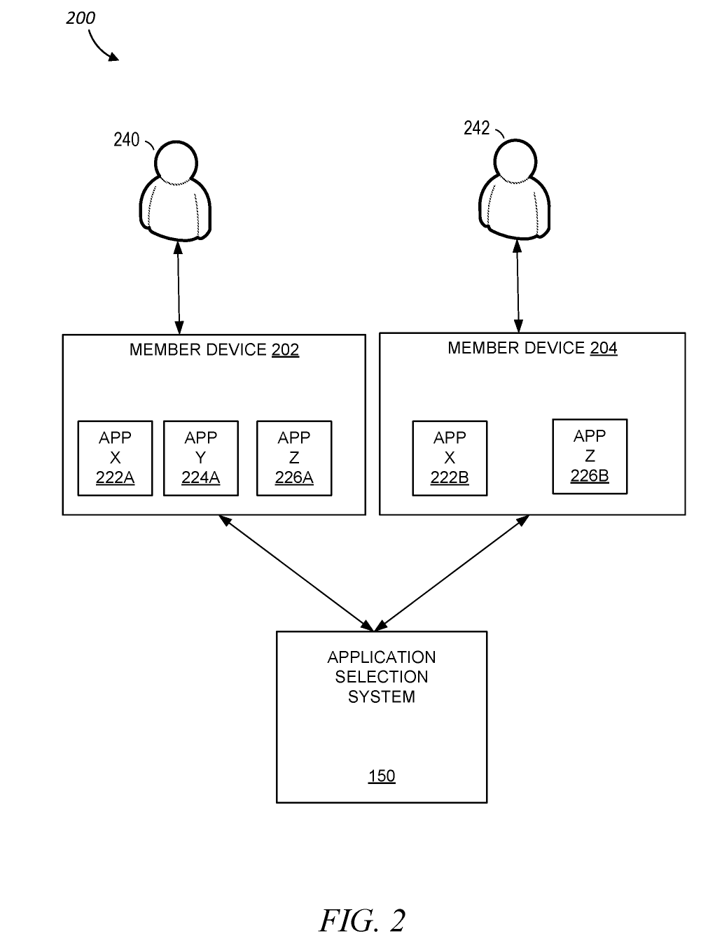

FIG. 2 is a block diagram illustrating one example system 200 for selecting an application for message handling according to one example embodiment. In this example embodiment, a first member 240 uses a first member computing device 202 that includes Application X 222A, Application Y 224A, and Application Z 226A. A second member 242 uses a second member computing device 204 that includes a different instantiation of Application X 222B and a different instantiation of Application Z226B.

In one example embodiment, the first member 240 uses the Application X 222A to generate a message destined for the second member 242. In this example, the Application X 222A transmits the message to the application selection system 150. The application selection system 150 then determines which application the member 240 used to generate the message, as will be further described. In one example, the application selection system 150 determines that the member 240 generated the message using Application X 222A due to the format of the message. In one example, the Application X 222A is a recipe application and the message is in a standard recipe format. Therefore, in one example embodiment, the application selection system 150 determines which application was used to generate the message based, at least in part, on the format of the message.

The application selection system 150 then receives a reply message from the second member 242 and transmits the reply message to the computing device 202 used by the member 240. The application selection system 150, in one example embodiment, indicates to the computing device 202 which application (e.g., 222A, 224A, or 226A) is to be used to handle the reply message.

In another example embodiment, the member 240 uses Application Y 224A to generate a message to be sent to a destination member, such as the second member 242. The application selection system 150 determines that the member 240 used Application Y 224A to generate the message and transmits the message to a computing device 204 used by the second member 242. In this example, an instantiation of Application Y is not installed on the member computing device 204 and the second member 242 uses a different application to generate a reply message (e.g., Application X 222B or Application Z 226B).

In response to receiving a reply message from the computing device 204 used by the second member 242, the application selection system 150 transmits the reply message back to Application Y 224A because Application Y 224A was used by the member 240 to generate the initial message. Therefore, in some embodiments, it is not necessary that instantiations of applications used to communicate between members (e.g., 240, 242) be consistent across member devices (e.g., 202 and 204). In this example, member 240 used an instantiation of Application Y to generate an initial message although member 242 used an instantiation of Application X to generate a reply message.

In another example embodiment, the member computing device 204 is a wearable device that lacks capability to install a version of Application X. In this example, although the member 240 used Application X 222A to generate a message to the member 242, the member 242 may use Application Z 226B to handle the message and generate a reply message, which the application selection system 150 transmits to Application X 222A because Application X 222A was first used to send a message to the member 242.

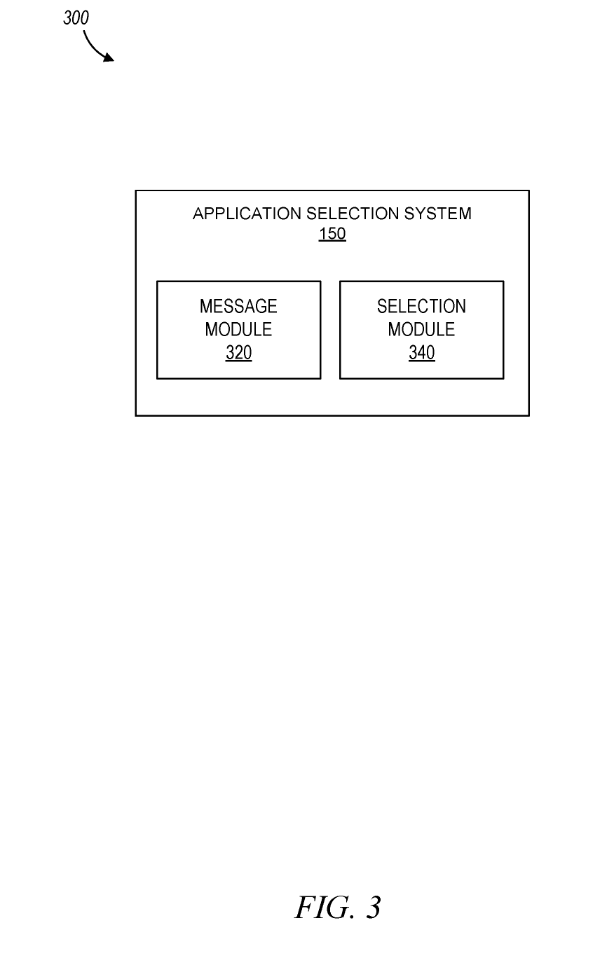

FIG. 3 is a block diagram illustrating another example system 300 for selecting applications for message handling according to one example embodiment. The application selection system 150, in one example embodiment, includes a message module 320 and a selection module 340.

In one example embodiment, the message module 320 is configured to receive a message from a source member of an online social networking service using a source computing device. In one example, the source member directs the message to a destination member of the online social networking service 100. As will be described in greater detail, the selection module 340 determines an application used by the source member to generate the message.

In another example embodiment, the message module 320 receives a reply to the message. In certain embodiments, a reply message includes, but is not limited to, a message that includes the original message, a message that temporally coincides with the original message, or other technique to determine that a message is in reply to another message. In one example, the message module 320 determines that another message is a reply message because the message includes text from the original message. In another example, the message module 320 determines that another message is a reply message because the message is received from the destination member and is directed towards the source member and received within one minute of sending the original message. Of course, other time periods may be used and this disclosure is not limited in this regard.

In one example embodiment, the message module 320 transmits the reply message to the source computing device including indication that the determined application is to be used to handle the reply message. In this way, reply messages are handled by the same application used to generate the original message.

In another example embodiment, after sending an original message, the source member may uninstall the application used to generate the original message. In one example, the message module 320 is notified by the source computing device that the application used to generate the message has been uninstalled. As a reply message is received, according to one example embodiment, in response to determining that the source computing device no longer includes the application used to generate the message, the message module 320 transmits a request to the source computing device to install the application.

In one example embodiment, in response to determining that the source computing device no longer includes the application used to generate the message, the message module 320 transmits a request to the source computing device to handle a reply message using a different application. In one example, the different application is a generic message handling application.

In another example embodiment, the message module 320 provides an interface to access the reply message without the application. In one example, the interface is a web-based application distributed by the application selection system 150. In this example, a member of the online social networking service 100 can view messages and/or reply to messages using the web interface. In one example where a computing device for a member does not include the application needed to view the message, the member may access the message using the interface.

In one example embodiment, in response to the member viewing the reply message using the interface, the message module 320 transmits a notification to the application. In this way, the member is not alerted to receiving a reply message when the member had already viewed the reply message using the interface.

In certain example embodiments, by ensuring that reply messages are handled by applications that originally generated the messages, the application selection system 150 tracks specific conversations between members of the online social networking service 100 and helps ensure that messages transmitted between the members are handled by the correct message applications. In one example, a member of the online social networking service 100 has conversations with other members using different applications and the application selection system 150 maintains correct application usage as described herein by tracking applications that generate original messages.

In another example embodiment, the selection module 340 is configured to determine which application a source member used to generate a message. In one example, the selection module 340 determines whether more than one message application is installed on a source computing device. In one example, the selection module 340 queries the source computing device. In another example, an application executing at the source computing device reports which applications are installed. Of course, one skilled in the art may recognize other ways in which a system determines which applications are installed on a computing device and this disclosure is meant to include all such ways.

In certain embodiments, a variety of different applications are installed on a computing device used by a member of the online social networking service 100. In one example, applications include a business application, a personal application, a confidential communications application, a cooking application, a pet application, a shopping application, a home furnishings application, an automobile application, a hobbies application, a financial application, an employment application, a scheduling application, a benefits application, a medical application, or other, or the like. Of course, any of these application may be configured to receive and/or transmit messages. In another example embodiment, the application selection system 150 provides one or more of these applications to computing devices for members of the online social networking service 100 according to their preferences and configuration decisions.

In one example embodiment, the member has provided an indication of which application is to be used to handle messages and the selection module 340 determines the application based, at least in part, on the user's preference.

In another example embodiment, the selection module 340 determines which application was used to generate the message based, at least in part, on an application used by the member to generate a previous message.

In other embodiment, the selection module 340 determines which application was used to generate a message based on a source formatting of the message. In one example, the message is in a hyper-text-markup-language (HTML) format and includes a tag indicating an application used to generate the message. In another example embodiment, the selection module 340 determines which application was used to generate the message based on content included in the message. In one example, content in the message includes an employment application, and in response, the selection module 340 determines that an employment application was used to generate the message. In another example, content in the message includes a calendar notification, and in response, the selection module 340 determines that the application used to generate the message is a scheduling application.

In another example embodiment, the selection module 340 determines which application was used to generate a message based, at least in part, on the location of the member (or a computing device used by the member). In one example, in response to the member being at work, the selection module 340 determines that the member used a professional application to generate the message. In one example embodiment, the selection module 340 compares a list of application at the member's computing device with application that are designated as “professional.” In one example embodiment, a remote database stores a list of applications and respective classifications (e.g., professional, personal, family, romantic, etc.). In response to a match, the selection module 340 determines the classification of the application and in turn determines the application as described herein.

In another example, in response to the member being at home, the selection module 340 determines that the user used a personal application to generate a message. Of course, this is not necessarily the case, but only illustrates one of a wide variety of different factors the selection module 340 may use to determine an application used to generate a message.

In another example embodiment, in response to a source member having a personal relationship with a destination member, the selection module 340 determines that the application used to generate the message is a personal application. In certain embodiments, a personal application is an application capable of generating a message and is specifically tailored to personal conversations between people that share a personal relationship. Therefore, in response to a message between transmitted between friends or family members, the selection module 340 determines that the member used the personal application or a family application. In another example embodiment, in response to a connection strength between a source member and a destination member at the online social networking service 100 being above a threshold value, the selection module 340 determines that the application used to generate a message from the source member to the destination member is a personal application. In one example, the connection strength is based on an amount of time (e.g. more than 10 years) the source member and the destination member have been connected via the online social networking service 100. In another example, the connection strength is a number of messages (e.g., more than 1000) the source member and the destination member have transmitted between each other. In another example, the connection strength is based on familial relationship (e.g., siblings, parents, children, cousins, or the like).

In one example embodiment, the methods described herein allow a source member to maintain different conversations with different destination members using different applications, and allow reply message to be directed to the applications used to generate the original messages.

In another example embodiment, the application selection system 150 supports group messaging. In one example, a member may generate a message using an application and direct the group message to many recipients (e.g., other members of the online social networking service 100). In this way, a member (or the application selection system 150) may transmit a message to many members, and only members that have an application needed to handle the message may view the message. Furthermore, members of the online social networking service 100 may have public and/or private conversations with other members. In other embodiments, a member may use a specific application to generate a message and the message may be transmitted to all other members of the online social networking service 100 that use a specific application. In this example, members of the online social networking service 100 that do not have the specific application do not receive the message.

In another example embodiment, the selection module 340 may convert a message to a generic format and request a generic message handling application in response to the messaging being an emergency message. In one example, the member generating the message indicates that the message is an “emergency,” and the message module 320 reformats the message for transmission to ensure that an increased number of members receive the message.

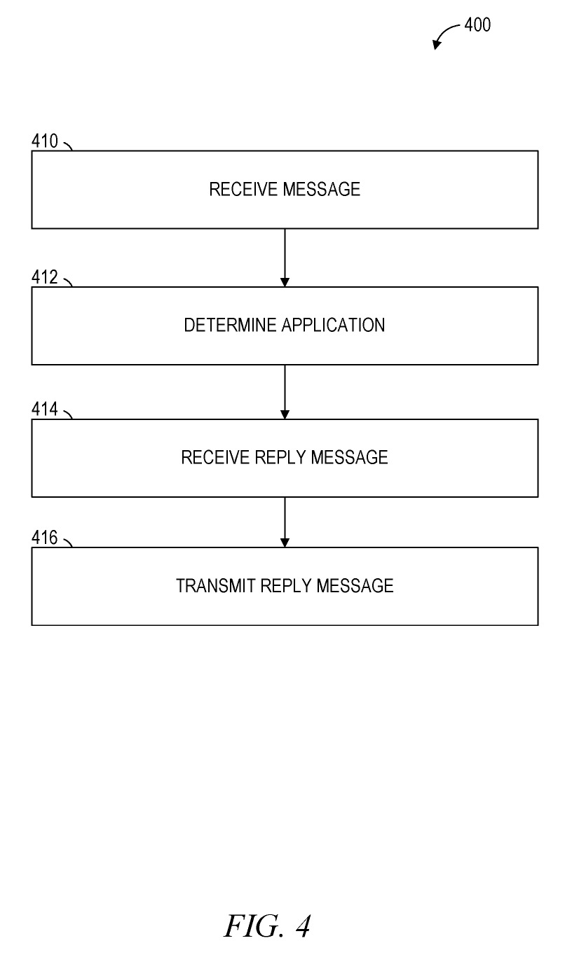

FIG. 4 is a flow chart diagram illustrating a method 400 of selecting applications for message handling according to an example embodiment. The operations described in FIG. 4 may be performed by one or more components of the application selection system 150, and are discussed by way of reference thereto. As shown in FIG. 4, the method 400 includes operations 410, 412, 414, and 416.

In one example embodiment, the method 400 begins and at operation 410 the message module 320 receives a message from a source member of an online social networking service (e.g., the online social networking service 100) using a source computing device. In another example, the message is directed to a destination member of the online social networking service 100.

The method 400 continues at operation 412 and the selection module 340 determines which application the source member used to generate the message. In another example, the selection module 340 determines the application in response to more than one application being available to handle messages at the computing device used by the member.

The method 400 continues at operation 414 and the message module 320 receives a reply message from the destination member. In one example, the reply message is received by the message module 320 and includes the original message.

The method 400 continues and at operation 416 the message module 320 transmits the reply message to the source computing device including indication that the application is to be used to handle the reply message. In one example, the message is formatted to include an indicator indicating the application to be used.

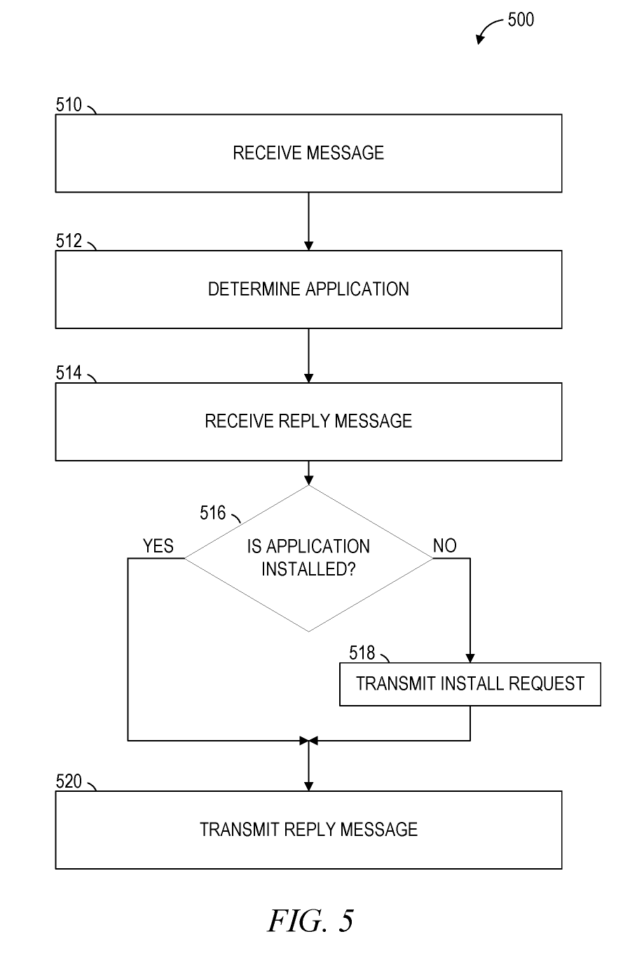

FIG. 5 is another flow chart diagram illustrating a method 500 of selecting applications for message handling according to an example embodiment. The operations described in FIG. 5 may be performed by one or more components of the application selection system 150, and are discussed by way of reference thereto. As shown in FIG. 5, the method 500 includes operations 510, 512, 514, 516, 518, and 520.

In one example embodiment, the method 500 begins and at operation 510 the message module 320 receives a message from a source member of an online social networking service (e.g., the online social networking service 100) using a source computing device. In another example, the message is directed to another member of the online social networking service 100.

The method 500 continues at operation 512 and the selection module 340 determines which application the source member used to generate the message. In another example, the selection module 340 determines the application in response to more than one application being available to handle messages at the computing device used by the member.

The method 500 continues at operation 514 and the message module 320 receives a reply message from another member. In one example, the reply message is received including an indicator indicating the original message.

The method 500 continues at operation 516 and the selection module 340 determines whether a specific application needed to handle the message is installed at the source computing device used by the member that originally transmitted the message that was replied to. In response to determining that the application is installed at the computing device, the method 500 continues at operation 520. In response to determining that the application is not installed at the computing device, the method 500 continues at operation 518.

At operation 518, the message module 320 transmits a request to install the indicated application to the source computing device. In one example, the message module 320 transmits a notification to a generic message handling application requesting the member to install the application. At operation 520 the message module 320 transmits the reply message to the source computing device including indication that the application is to be used to handle the reply message.

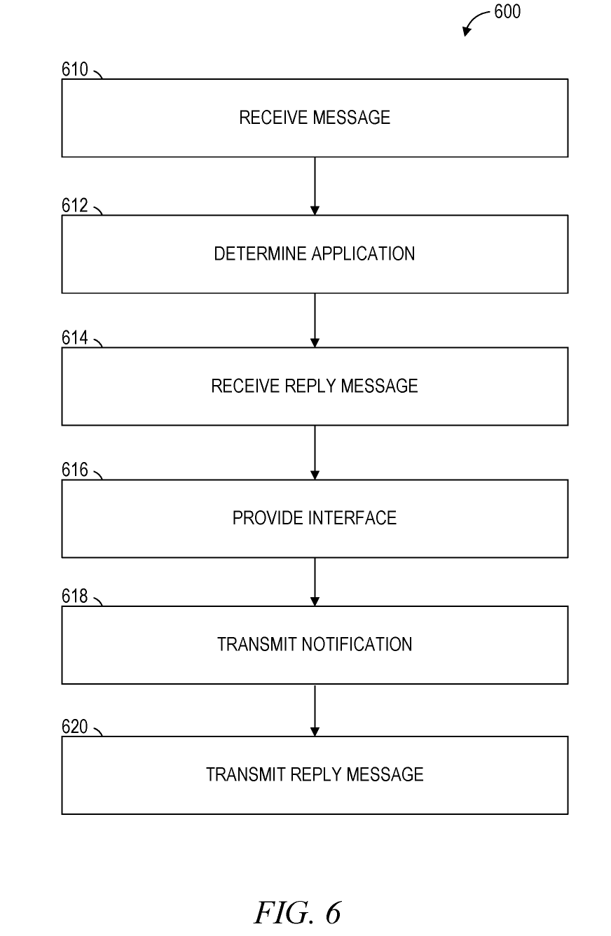

FIG. 6 is a flow chart diagram illustrating a method 600 of selecting applications for message handling according to another example embodiment. The operations described in FIG. 6 may be performed by one or more components of the application selection system 150, and are discussed by way of reference thereto. As shown in FIG. 6, the method 600 includes operations 610, 612, 614, 616, 618, and 620.

In one example embodiment, the method 600 begins and at operation 610 the message module 320 receives a message from a source member of an online social networking service (e.g., the online social networking service 100) using a source computing device. In another example, the message is directed to a destination member of the online social networking service 100.

The method 600 continues at operation 612 and the selection module 340 determines which application the source member used to generate the message. In another example, the selection module 340 determines the application in response to more than one application being available to handle messages at the computing device used by the member.

The method 600 continues at operation 614 and the message module 320 receives a reply message from the destination member as described herein. The method 600 continues at operation 616 and the message module 320 provides an interface for the computing device used by the source member to access the reply message. In one example, the interface includes an application programming interface (API) allowing a remote system to access messages at the online social networking service 100.

The method 600 continues at operation 616 and the message module 320 transmits a notification to the source computing device indicating that the reply message was received by the application selection system 150. In one example, selecting the notification accesses the reply message using the interface. In another example, selecting the notification accesses the reply message using an indicated application.

The method 600 continues and at operation 620 the message module 320 transmits the reply message to the source computing device including indication that the application is to be used to handle the reply message.

In certain example embodiments, the application selection system 150 is configured to determine a specific application used by a member to generate a message. In response to receiving a reply to the message, the application selection system 150 can ensure that the reply is sent to the application. In this way, the application selection system keeps conversations contiguous between applications. Thus, the application selection system 150 keeps separate conversations between members of an online social networking service separately. In other example embodiments, conversations, even between the same members, are kept in their respective applications. In this way, certain members of the online social networking service can maintain personal and professional conversations in separate applications so that they are not mixed together. Thus, this disclosure provides a technical solution to the problem of messages transmitted using multiple different messaging applications and keeping the respective conversations separate and contiguous.

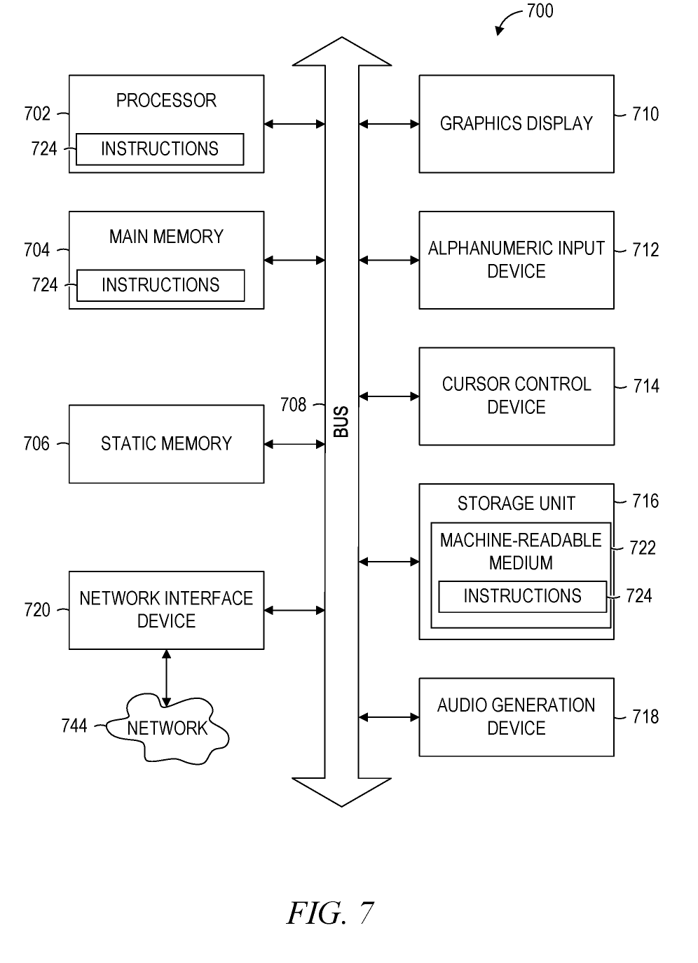

FIG. 7 is a block diagram illustrating components of a machine able to read instructions from a machine-readable medium. Specifically, FIG. 7 shows a diagrammatic representation of the machine 700 in the example form of a computer system and within which instructions 724 (e.g., software) for causing the machine 700 to perform any one or more of the methodologies discussed herein may be executed. In alternative embodiments, the machine 700 operates as a standalone device or may be connected (e.g., networked) to other machines. In a networked deployment, the machine 700 may operate in the capacity of a server machine or a client machine in a server-client network environment, or as a peer machine in a peer-to-peer (or distributed) network environment. The machine 700 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 724, sequentially or otherwise, that specify actions to be taken by that machine. Further, while only a single machine 700 is illustrated, the term “machine” shall also be taken to include a collection of machines that individually or jointly execute the instructions 724 to perform any one or more of the methodologies discussed herein. In certain embodiments, the various modules described in FIG. 4 are implemented as part of the instructions 724.

The machine 700 includes a processor 702 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 704, and a static memory 706, which are configured to communicate with each other via a bus 708. The machine 700 may further include a graphics display 710 (e.g., a plasma display panel (PDP), a light emitting diode (LED) display, a liquid crystal display (LCD), a projector, or a cathode ray tube (CRT)). The machine 700 may also include an alphanumeric input device 712 (e.g., a keyboard), a cursor control device 714 (e.g., a mouse, a touchpad, a trackball, a joystick, a motion sensor, or other pointing instrument), a storage unit 716, an audio generation device 718 (e.g., a speaker), and a network interface device 720.

The storage unit 716 includes a machine-readable medium 722 on which is stored the instructions 724 (e.g., software) embodying any one or more of the methodologies, modules, or functions described herein. The instructions 724 may also reside, completely or at least partially, within the main memory 704, within the processor 702 (e.g., within the processor's cache memory), or both, during execution thereof by the machine 700. Accordingly, the main memory 704 and the processor 702 may be considered as machine-readable media. The instructions 724 may be transmitted or received over a network 744 via the network interface device 720.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 722 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions (e.g., software) for execution by a machine (e.g., machine 700), such that the instructions (e.g., instructions 724), when executed by one or more processors of the machine (e.g., processor 702), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A system comprising:
one or more hardware processors;
a machine-readable medium having instructions stored thereon, which, when executed by the one or more hardware processors, configure the system to:
receive a first message from a first member of an online social networking service using a first computing device, the first message addressed to a second member of the online social networking service;
determine an application selected from a plurality of applications installed on the first computing device and capable of generating the first message, which application the first member used to generate the first message;
receive a second message from the second member, the second message being a reply message to the first message; and
transmit the second message to the first computing device that includes an instruction that the determined application is to handle the second message.

2. The system of claim 1, wherein the instructions further cause the system to transmit a request to the first computing device to install the determined application in response to the application not being installed on the first computing device.

3. The system of claim 1, wherein the instructions further cause the system to transmit a request to the first computing device to handle the second message using an application that is different from the determined application in response to the determined application not being installed on the first computing device.

4. The system of claim 1, wherein the instructions further cause the system to communicate an interface to the first computing device to access the second message without the application.

5. The system of claim 1, wherein the first message is an original message for further messages, the further messages are also handled using the determined application.

6. The system of claim 1, wherein the application is determined using at least one of a first message format, a type of the first message, a location of the first member when generating the first message, a personal relationship between the first member and the second member, and a social network connection strength between the first member and the second member.

7. The system of claim 1, wherein the instructions further cause the system to transmit a notification to the first computing device, the notification indicating the application.

8. A method comprising:
receiving a first message from a first member of an online social networking service using a first computing device, the first message being intended for a second member of the online social networking service;
determining an application selected from a plurality of applications installed on the first computing device and capable of generating the first message, which application the first member used to generate the first message;
receiving a second message from the second member, the second message being a reply message to the first message; and
transmitting the second message to the first computing device that includes an instruction that the determined application is to handle the second message.

9. The method of claim 8, further comprising transmitting a request to the first computing device to install the determined application in response to the application not being installed on the first computing device.

10. The method of claim 8, further comprising transmitting a request to the first computing device to handle the second message using an application that is different from the determined application in response to the determined application not being installed on the first computing device.

11. The method of claim 8, further comprising communicating an interface to the first computing device to access the second message without using the determined application.

12. The method of claim 8, wherein the first message is an original message for further messages, the method further comprising handling the further messages using the determined application.

13. The method of claim 8, wherein the application is determined using at least one of a first message format, a type of the first message, a location of the first member when generating the first message, a personal relationship between the first member and the second member, and a social network connection strength between the first member and the second member.

14. The method of claim 8, further comprising transmitting a notification to the first computing device, the notification indicating reception of the second message and indicating the determined application.

15. A machine-readable hardware medium having instructions stored thereon, which, when executed by one or more hardware processors, cause the one or more processors to perform:
receiving a first message from a first member of an online social networking service using a first computing device, the first message being intended for a second member of the online social networking service;
determining, in response to more than one application being available via the first computing device and capable of generating the first message, which application the first member used to generate the first message;
receiving a second message from the second member, the second message being a reply message to the first message; and
transmitting the second message to the first computing device that includes an instruction that the determined application is to handle the second message.

16. The machine-readable hardware medium of claim 15, wherein the instructions further cause the one or more processors to transmit a request to the first computing device to install the determined application in response to the determined application not being installed on the first computing device.

17. The machine-readable hardware medium of claim 15, wherein the instructions further cause the one or more processors to transmit a request to the first computing device to handle the second message using an application that is different from the determined application in response to the determined application not being installed on the first computing device.

18. The machine-readable hardware medium of claim 15, wherein the instructions further cause the one or more processors to communicate an interface to the first computing device to access the second message without the determined application.

19. The machine-readable hardware medium of claim 15, wherein the application is determined using at least one of a first message format, a type of the first message, a location of the first member when generating the first message, a personal relationship between the first member and the second member, and a social network connection strength between the first member and the second member.

20. The machine-readable hardware medium of claim 15, wherein the instructions further cause the one or more processors to transmit a notification to the first computing device, the notification indicating the application.
